(19) United States
(12) Patent Application Publication
(10) Pub. No.: US 2019/0387716 A1
(43) Pub. Date: Dec. 26, 2019

(54) Pet Traction Device

(71) Applicant: Dongguan Jiasheng Enterprise Co., Ltd., Dongguan City (CN)

(72) Inventor: Silong Chen, Dongguan City (CN)

(73) Assignee: Dongguan Jiasheng Enterprise Co., Ltd.

(21) Appl. No.: 16/219,505

(22) Filed: Dec. 13, 2018

(30) Foreign Application Priority Data
Jun. 25, 2018 (CN) 201810664081.3

(51) Int. Cl. A01K 27/00

(52) U.S. Cl. CPC A01K 27/004

(57) ABSTRACT

A pet traction device includes a housing, a reel, a switch button and a brake paddle. A reel frame is mounted into the housing; the reel is rotatably installed into the reel frame; a brake position is defined at a position with a spacing from the reel and corresponding to a free end of the brake paddle; the brake paddle is pivoted to the housing through a pin shaft; a torsion spring is sheathed on a pin shaft; the torsion spring has a section fixed to a protrusion of the reel frame and the other end abutting an inner wall of the brake paddle; the brake portion corresponds to an arc bottom of the switch button; and the switch button has a movable latching portion corresponding to a fixed latching portion disposed in the housing and proximate to the rear of the switch button.

### FIELD OF THE INVENTION

The present invention relates to the field of pet appliances, and more particularly to a pet traction device.

### BACKGROUND OF THE INVENTION

In general, a pet traction device comprises a housing, a reel, a switch button, a transmission part and a brake paddle. In an operation, a forward external force is applied to the switch button, and when the switch button presses a pivoting end of the transmission part, the transmission part presses a free end of the brake paddle through a spring, the spring is compressed, and the brake paddle is rotated, so that the free end of the brake paddle is latched into the brake position of the brake paddle. Now, users have to press the switch button continuously, or else the spring will resume its resilience to reset the brake paddle. As a result, the dog leash may enter into or exit from the reel freely, and a normal operation of the dog traction device cannot be ensured.

In view of the aforementioned drawbacks of the prior art, the inventor of the present invention based on years of experience to conduct extensive research and experiment, and finally provided a feasible solution to overcome the drawbacks of the prior art.

### SUMMARY OF THE INVENTION

Therefore, it is a primary objective of the present invention to overcome the aforementioned drawbacks of the prior art by providing a pet traction device with the feature of convenient operation and assuring a normal operation.

To achieve the aforementioned and other objectives, the present invention provides a pet traction device, comprising: a housing, a reel, a switch button and a brake paddle, characterized in that the housing has a reel frame installed therein, and the reel is rotatably installed in the reel frame, and a brake position is defined at a positon with a spacing from the reel and configured to be corresponsive to a free end of the brake paddle, and the brake paddle is pivotally coupled into the housing through a pin shaft, and a torsion spring is sheathed on the pin shaft, and the torsion spring has a section fixed to a protrusion of the reel frame and the other end abutting an inner wall of the brake paddle, and the brake portion of the brake paddle is configured to be corresponsive to an arc bottom of the switch button, and the switch button has a movable latching portion disposed thereon and configured to be corresponsive to a fixed latching portion disposed in the housing and proximate to the rear of the switch button.

Compared with the prior art, the present invention has the following beneficial effects: The aforementioned structural design of the present invention not just provides a convenient operation only, but also ensures the normal operation of the dog traction device.

### BRIEF DESCRIPTION OF THE DRAWINGS

FIG. 1 is an exploded view of a pet traction device of the present invention.

### BRIEF DESCRIPTION OF NUMERALS IN THE FIGURES

(1) Housing, (2) Reel, (3) Switch button, (4) Brake paddle, (5) Reel frame, (6) Brake position, (7) Pin shaft, (8) Torsion spring, (9) Protrusion, (10) brake portion, (11) fixed latching portion, (12) movable latching portion.

### DESCRIPTION OF THE PREFERRED EMBODIMENTS

The technical contents of the present invention will become apparent with the detailed description of preferred embodiments accompanied with the illustration of related drawings as follows.

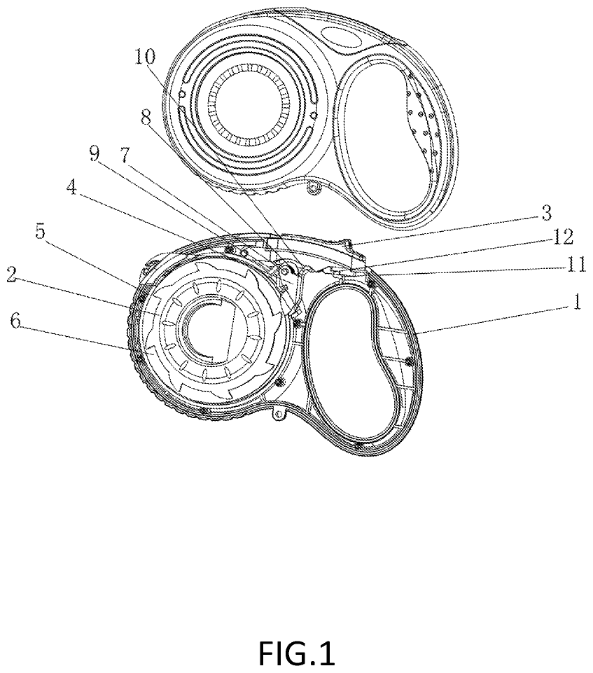

With reference to FIG. 1 for a pet traction device of the present invention, the pet traction device comprises a housing 1, a reel 2, a switch button 3, and a brake paddle 4. The housing 1 has a reel frame 5 installed therein, and the reel 2 is rotatably installed into the reel frame 5, and the reel 2 has a brake position 6 defined at a position with a spacing from the reel 2 and configured to be corresponsive to a free end of the brake paddle, and the brake paddle 4 is pivotally coupled into the housing 1 through a pin shaft 7, and the pin shaft 7 has a torsion spring 8 sheathed thereon, and a section of the torsion spring 8 is fixed to a protrusion 9 of the reel frame 5, and the other end of the torsion spring 8 abuts an inner wall of the brake paddle 4, and the brake portion 10 of the brake paddle 4 is configured to be corresponsive to an arc bottom of the switch button 3, and the switch button 3 has a fixed latching portion 11 disposed in the housing 1 and proximate to the rear of the switch button 3 and configured to be corresponsive to a movable latching portion 12.

During the operation of the pet traction device of the present invention, a user applies a forward external force to the switch button 3, and the arc bottom of the switch button 3 presses a brake portion of the brake paddle 4, so that the brake paddle 4 is rotated counterclockwise around the pin shaft 7, and the torsion spring 8 is stretched. Now, the fixed latching portion and the movable latching portion are staggered. When the switch button 3 is pressed, the arc bottom of the switch button presses the brake portion of the brake paddle 4, so that the brake paddle 4 is rotated clockwise around the pin shaft 7, and the torsion spring is compressed to latch the free end of the brake paddle 4 into the brake position. When the user applies a backward external force to the switch button 3, the movable latching portion 12 is latched to the bottom of the fixed latching portion 11. Now, the user no longer needs to apply the external force to the switch button 3 continuously to ensure the normal operation of the dog traction device.

In summation, the present invention overcomes the drawbacks of the prior art by the aforementioned structural design, and the invention has the features of reasonable structure, quick and convenient operation, etc.

While the present invention has been described by means of specific embodiments, numerous modifications and variations could be made thereto by those skilled in the art without departing from the scope and spirit of the present invention set forth in the claims.

What is claimed is:

1. A pet traction device, comprising: a housing, a reel, a switch button and a brake paddle, characterized in that the housing has a reel frame installed therein, and the reel is rotatably installed in the reel frame, and a brake position is defined at a positon with a spacing from the reel and configured to be corresponsive to a free end of the brake paddle, and the brake paddle is pivotally coupled into the housing through a pin shaft, and a torsion spring is sheathed on the pin shaft, and the torsion spring has a section fixed to a protrusion of the reel frame and the other end abutting an inner wall of the brake paddle, and the brake portion of the brake paddle is configured to be corresponsive to an arc bottom of the switch button, and the switch button has a movable latching portion disposed thereon and configured to be corresponsive to a fixed latching portion disposed in the housing and proximate to the rear of the switch button.
